(19) United States
(12) Patent Application Publication
(10) Pub. No.: US 2024/0185156 A1
(43) Pub. Date: Jun. 6, 2024

(54) METHOD FOR ELABORATION OF ROAD LAYOUTS, PIPELINE LINES AND ESCAPE ROUTES IN A GEOGRAPHIC INFORMATION SYSTEM

(71) Applicants: PETROLEO BRASILEIRO S.A .-PETROBRAS, Rio de Janeiro (BR); UNIVERSIDADE FEDERAL RURAL DO RIO DE JANEIRO-UFRRJ, Seropédica (BR)

(72) Inventors: Frederico Santos MACHADO, Rio de Janeiro (BR); Wesley De Souza DA SILVA, Seropédica (BR); Marcos Bacis CEDDIA, Seropédica (BR); Jorge Eduardo SANTOS PAES, Rio de Janeiro (BR); Andre Luis DE OLIVEIRA VILLELA, Seropédica (BR)

(21) Appl. No.: 18/526,668

(22) Filed: Dec. 1, 2023

(30) Foreign Application Priority Data
Dec. 4, 2022 (BR) BR 1020220247870

(51) Int. Cl. G06Q 10/0631; G06Q 10/047

(52) U.S. Cl. CPC G06Q 10/06316; G06Q 10/047

(57) ABSTRACT

Soil maps are rarely used for the elaboration of road layouts, and there are no known algorithms that incorporate soil information dynamically. The best way to incorporate this knowledge of soils is to interpret the soil maps into a derived (interpreted) map known as the “road, pipelines and operational locations aptitude map”. This study generated an innovative algorithm that incorporates soil aptitude maps for road layouts, pipeline lines and escape routes. The novelty of the algorithm is that this aptitude information (interpreted from a map of soil classes) is collated together with relief and hydrography information. Thus, it is hypothesized that, in addition to the characteristics of the relief and proximity of watercourses, the soil map can help the decision-maker to unveil regions with serious problems that increase the costs of construction and maintenance of roads, pipelines, escape routes and operating locations.

### FIELD OF THE INVENTION

The present invention falls within the field of road infrastructure. More specifically, the present invention relates to a method for automatically determining an optimal layout for roads, pipeline lines, and escape routes.

### BACKGROUND OF THE INVENTION

The works related to use planning and management of land in operational areas, regardless of the objectives, require the incorporation of different types of information to enhance the decision-making process. Among the different demands that technicians from companies in the oil and gas field need to respond to, the planning of roads, pipeline lines and escape routes stands out. The definition of the best layout should incorporate and contemplate information on relief, hydrography, land use and cover, and soil types, combined with the lowest cost (in this case, both construction and maintenance costs). Sanjeevi and Shahabudeen (2016) argue that the criteria for implementing locations, roads and pipelines have specificities that can differentiate the procedure for generating maps. Among the most used information (due to greater availability) are topography maps and drainage lines (Gallant and Dowling, 2003). However, it is common knowledge that the lands with the best aptitude for roads, pipelines and works must have a combination of good drainage, low slope and soils that do not present high expansibility, stickiness and plasticity, and high levels of silt, clay and organic material. Aptitude maps are essential for the development of algorithms for simulating road layouts, pipeline lines and escape routes, and the generation of these maps, according to Heineke et al. (1998), is generally static, i.e., maps of factors that affect the topic of interest are used and data processing procedures (spatial analysis in geographic information systems) are created to classify pixels according to their potentiality, which can be attributed as good, medium or low.

### STATE OF THE ART

Document US2021141966 A1, published on May 13, 2021, and titled “Constraint based automatic terrain surface design”, refers to a method and a system that provide the ability to design a terrain surface. A triangular surface mesh representative of an existing surface is obtained. One or more constraints to control the triangular surface mesh are specified. The drainage for the triangular surface mesh is automatically determined based on the constraints. The triangular surface mesh is optimized based on drainage and one or more design options. Optimization modifies the triangular surface mesh to define the drain flow for the drainage. The paper also discloses a computer-implemented method for generating road designs on a map. Generation is guided by constraints that can be manually entered by the user, fed along with the area map, and/or modified by the user.

### SUMMARY OF THE INVENTION

Soil maps are rarely used for the elaboration of road layouts, and there are no known methods that incorporate soil information dynamically. The best way to incorporate this knowledge of soils is to interpret the soil maps into a derived (interpreted) map known as the “road, pipelines and operational locations aptitude map”. This study generated an innovative method that incorporates soil aptitude maps for road layouts, pipeline lines and escape routes. The novelty of the method is that this aptitude information (interpreted from a map of soil classes) is collated together with relief and hydrography information. Thus, it is hypothesized that, in addition to the characteristics of the relief and proximity of watercourses, the soil map can help the decision-maker to unveil regions with serious problems that increase the costs of construction and maintenance of roads, pipelines, escape routes and operating locations.

### BRIEF DESCRIPTION OF THE DRAWINGS

The present invention will be described below with reference to the typical embodiments thereof and also with reference to the attached drawings, wherein:

FIG. 1 is a representation of an exemplifying digital soil map according to this invention;

FIG. 2 is a representation of an exemplifying aptitude map for opening roads, pipelines and operating locations, according to this invention;

FIG. 3 is an exemplifying flowchart of the method according to the this invention;

FIG. 4 is a representation of the Toolbox in ArcGis according to this invention;

FIG. 5 is an illustrative representation of an alternative layout compared to the original layout according to this invention.

### DETAILED DESCRIPTION OF THE INVENTION

Specific embodiments of this disclosure are described below. In an effort to provide a concise description of these embodiments, all features of an actual implementation may not be described in the specification. It should be noted that, in the development of any actual implementation, as in any engineering or design project, numerous specific implementation decisions must be made to achieve the specific objectives of the developers, such as compliance with system- and business-related constraints, which may vary from one implementation to another. Moreover, it should be noted that such a development effort may be complex and time-consuming, but it would nevertheless be a routine undertaking of design, and manufacturing for those skilled in the art having the benefit of this disclosure.

The present invention is based on a soil aptitude map for defining the optimal layout of a road or pipeline to be built.

The thematic aptitude maps for opening roads, pipelines and operating locations of Juruá, Araracanga and Urucu were generated from the digital soil map presented in FIG. 1, which is a digital soil map of Juruá (A), Araracanga (B) and Urucu (C) divided into several Soil Mapping Units (MU). In addition to the soil information, the slope and the topographic wetness index (TWI) were also used and rated with grades. According to Table 1 below, the higher the grade, the worse the aptitude.

TABLE 1

| Aptitude class | Description | Grades |
|---|---|---|
| Very poor (U- or V-shaped | MU2 soils | 10 |
| valleys) | | |
| Very poor | MU1 or MU3 soils with slope > | 9 |
| | 15% and TWI < 10 | |
| Poor | MU4 | 8 |
| Regular | MU1 or MU3 soils with TWI > 10 | 5 |
| Good | MU1 or MU3 soils with slope | 2 |
| | between 8 and 15% and TWI < 10 | |
| Very good | MU1 or MU3 soils with slope < | 1 |
| | 8% and TWI < 10 | |

The grades above can vary, for example, from 1 to 10, where 1 represents the best possible aptitude and 10 represents the worst possible aptitude. It is also possible to leave the field empty, indicating that it is not desired for the layout to pass through the MU in question under any circumstances. Such grades are arbitrary and defined by the user designer according to any criteria that is deemed appropriate.

It is important to highlight that, for the method to work, it is necessary to provide maps of slope and topographic wetness index. These two maps are derived from the topographic map (with contour lines and drainage lines). The slope is derived directly from a toolbox available in several Geographic Information Systems (GIS). For the following description, we will use the ArcGis software as an example, although the present invention is not limited to it.

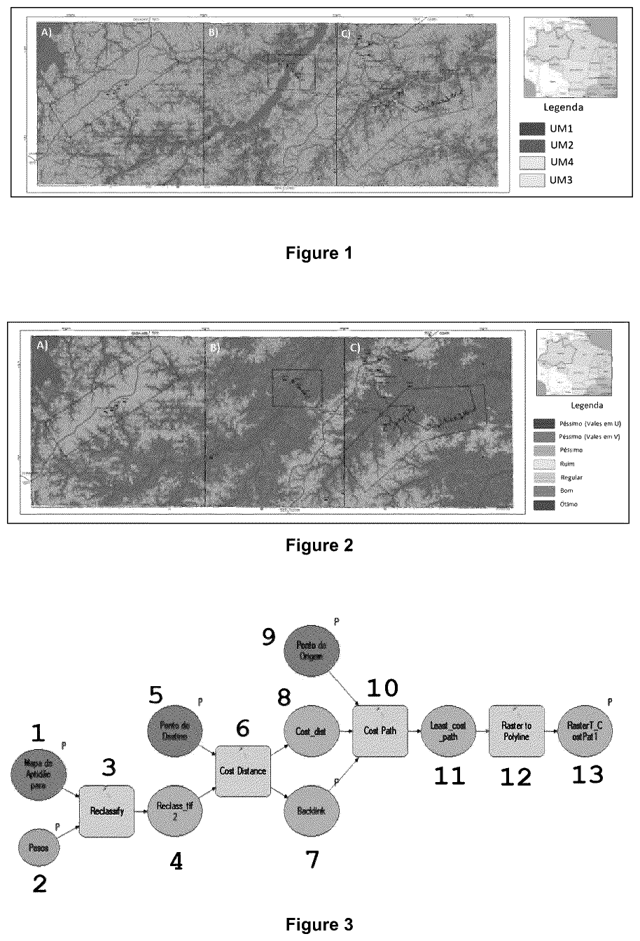

The final calculation of the TWI uses the slope, hydrography and the boundary of the river basins. Once these two maps (slope and TWI) and the soil class map (FIG. 1) are available, the user will be able to create the aptitude map for roads, pipeline lines and operating locations. This map, which for the study area is represented by FIG. 2, is used as an important support for assigning different grades to each of the classes presented in Table 1 above. It is important to note that this example in Table 1 refers to the case of the study area. The criteria adopted there are specific to soil, relief and local hydrography conditions, and may be quite different when applied to other areas. In other words, for each study area, the aptitude classes (Very poor, Poor, Regular, Good, and Very good) will have different combinations of Mapping Units (MU) of soils, slope, and TWI. This demonstrates that the method has the flexibility to be adjusted for each study region. The method matrix needs three pieces of information: a) the aptitude map, b) the start/departure geographic coordinates, and c) the end/arrival geographic coordinates of the road, pipeline line, or escape route. Finally, the scores exemplified in Table 1 may vary at the discretion of the designers responsible for the decision-making process. The user will be able to create numerous combinations of grades, which will generate different routes for roads, pipeline lines and escape routes. Optionally, the simulation can be carried out with different combinations of grades and/or different designers to find combinations of grades that contemplate the best response that not only considers environmental, but also cost aspects.

With reference now to FIG. 2, which is an aptitude map for opening roads, pipelines and operating locations in Juruá (A), Araracanga (B) and Urucu (C), and to Table 2, it can be observed that, in general, the lands with aptitude for opening roads, pipelines and locations grades as regular, good or very good are equivalent to 45.6% of the entire surveyed area. Similar values are also found for the regions of Urucu and Araracanga (45.8% and 44%, respectively). Quite different results are observed in the Juruá block, where only 12.5% of the land has a regular, good or very good aptitude class. This pattern reflects well the variability of the morphometric characteristics of Juruá in relation to the other flatter terrains with low convexity, which favors the process of soil hydromorphism.

TABLE 2

| Study area | Aptitude class | Area (%) |
|---|---|---|
| Total area | Very poor (U-shaped valleys) | 13.4 |
| | Very poor (V-shaped valleys) | 18.5 |
| | Very poor | 0.8 |
| | Poor | 21.6 |
| | Regular | 0.9 |
| | Good | 7.7 |
| | Very good | 37.0 |
| Urucu | Very poor (U-shaped valleys) | 15.4 |
| | Very poor (V-shaped valleys) | 22.6 |
| | Very poor | 0.4 |
| | Poor | 15.8 |
| | Regular | 0.7 |
| | Good | 5.3 |
| | Very good | 39.8 |
| Araracanga | Very poor (U-shaped valleys) | 29.8 |
| | Very poor (V-shaped valleys) | 23.3 |
| | Very poor | 1.1 |
| | Poor | 1.8 |
| | Regular | 1.9 |
| | Good | 4.7 |
| | Very good | 37.4 |
| Juruá | Very poor (U-shaped valleys) | 9.4 |
| | Very poor (V-shaped valleys) | 18.5 |
| | Very poor | 0.0 |
| | Poor | 59.6 |
| | Regular | 0.2 |
| | Good | 1.2 |
| | Very good | 11.1 |

According to Gietl, Doneus and Fera (2007), five ArcGis tools are used to develop the “road layout” method, namely: Reclassify 3, Cost Distance 6, Cost Path 10, Raster to Polyline 12, and Polygon to Line (not shown), as it is depicted in FIG. 3.

The differential of this method is the introduction of soil information 1 and 2 (soil aptitude for roads, escape routes and pipeline lines) as variables for decision-making. A relevant technical advantage is that, by introducing soil aptitude information, it is possible to account for the effects that soils cause on traffic and on the maintenance cost of access roads and pipeline lines in the planning and territorial management of an operational unit. These soil effects are neglected when only relief, terrain shape and hydrology information are used. In addition, unlike the algorithm of Gietl et al. in 2007, focused on archaeology, the present invention considers cases of the oil and natural gas industry.

To implement the method in an automated way, tools commonly available in geographic information systems (GIS) are used, which are presented with varying nomenclatures, depending on the system used. In this exemplifying embodiment, the GIS ArcGIS was used. Again, this invention is not limited to ArcGIS or any other specific GIS, and may be adapted to any existing or future GIS without departing from the scope of the present invention. The following items and the flowchart in FIG. 3 detail the tools employed and the steps performed by each one in implementing the method disclosed herein:
Tool allowing reclassification or alteration of each input pixel values on the map to alternative values (weights/grades—module 2 in FIG. 3). In ArcGIS, this tool is named Reclassify (module 3);
Tool calculating the minimum cumulative distance cost for each pixel on the map. In ArcGIS, this tool is named Cost Distance (Module 6);
Tool computing the least-cost layout from a start point to an end point. In ArcGIS, this tool is named Cost Path (Module 10);
Tool converting a set of Raster pixels to a Polyline. In ArcGIS, this tool is named Raster to Polyline (Module 12).

Thus, to carry out the method, simply insert an aptitude map (module 1), as shown in Table 1, assign weights (module 2, using the map in FIG. 2), define an origin point (module 9), and define a destination point (module 5), in addition to the flowchart in FIG. 3.

The Reclassify 3 tool assigns 2 weights to each soil mapping unit, the weights can range from 1 (Very good) to 10 (Very poor) or left empty, which is interpreted by ARcGis as NoData. The latter is chosen when the user does not want the road, pipeline or escape route to pass through a specific type of soil. The Cost Distance 6 tool is then used, which calculates the shortest cumulative cost distance for each cell to the nearest source on a cost surface. Then, the Cost layout 10 tool is used, thus generating a raster file that contains the shortest path 11 calculated on the surface, using the distance cost map 8 and the backlink 7. And finally, the layout is transformed from raster to vector with the Raster to Polyline 12 tool.

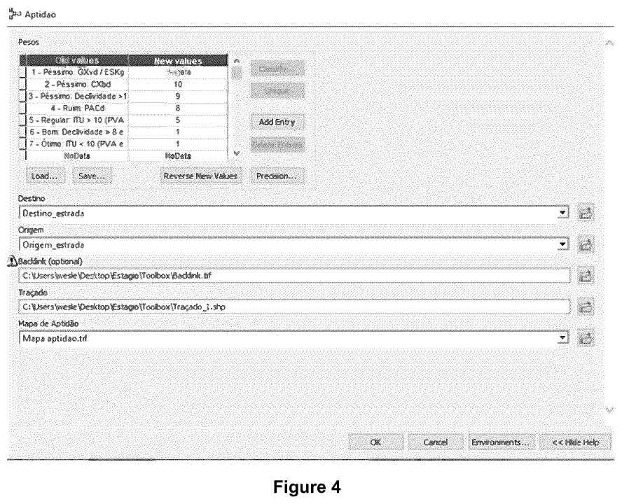

Next, the description of the toolbox for implementing the method disclosed herein in the GIS will be developed, referring to FIGS. 3 and 4.

To carry out the method, a toolbox was developed to be used in conjunction with an appropriate GIS, as can be seen in FIG. 4. In the example presented herein, the GIS is ArcGis. However, it should be noted that the present invention is not limited to this software, and can be applied to any other known or even future GIS, simply by making the necessary adaptations for the integration of the toolbox in each of them. The details of these integrations are not the focus of this invention, and therefore, they will not be covered here.

The toolbox Aptidão_Estradas.tbx aims to streamline and standardize the execution of layouts through a workflow or modelBuilder. The workflow in FIG. 3 is considered novel, because although the tools in a GIS already exist, they were organized, gathered and chained to generate the flow. This workflow implemented in the Aptidão_Estradas.tbx toolbox allows the native GIS tools, i.e. modules 3, 6, 10 and 12, to perform the functions sequentially once the information (soil aptitude for layouts, layout origin coordinates, and layout destination coordinates) has been entered.

In FIG. 3, modules 1, 2, 5 and 9 represent the data to be entered to generate the layout, according to the present invention. Module 1 refers to the soil aptitude map that will be inserted into the toolbox in the “Aptidao_refin.tif” field, while module 2 represents the weights/grades of the respective soil aptitudes measured by the user, which can be observed in the left column of the toolbox dialog box. Module 5 of FIG. 3 refers to the target coordinate of the layout, while module 9 refers to the origin coordinate of the layout. Both must also be entered by the user in the toolbox. Module 7 refers to a file named Backlink, which allows output data (module 8) to be automatically read by the tool represented by module 10. Modules 4, 8, 11 and 13 refer to the maps generated by the tools in the various stages. Thus, module 4 refers to the map reclassified in TIFF format, module 8 refers to the map with the cost of distance of each pixel, module 11 refers to the map with the lowest cost layout between the origin and destination point in raster format and, finally, module 13 refers to the same map (lowest cost between origin and destination) but transformed into polyline (vector format).

FIG. 4 shows the toolbox implemented in a GIS. The toolbox allows the user to perform the entire operation described in the workflow (workflow/modelbuilder—FIG. 3) in an interactive and user-friendly manner.

When opening the toolbox (aptidão_estradas.tbx), some fields will appear where it will be necessary to input information. In the dialog box named Reclassification, the legend of the soil aptitude classes (Very poor, Poor, Regular, Good and Very good) will appear in the left column. In the right column, the field where the user will assign grades to the respective aptitude classes will be displayed. In this column, the user will be able to vary these grades on a scale from 1 (very good) to 10 (very poor). In addition to these, there is also the option of putting, instead of numbers, the term NODATA. In this case, the user will create a constraint that will not allow the layout to pass through pixels with this classification. With the Reclassification dialog box, the tool represented by module 3 automatically transforms the aptitude class from text (very poor, poor, regular, good and very good) to numbers (reclassifies each pixel, for example, to 10, 8, 5, 2, and 1, respectively).

Also as it is shown in FIG. 4, below the Reclassification, other information must be filled in, namely:
Destination: in this field, the coordinate where the layout ends (point file) is provided;
The aptitude map (TIFF format);
Origin: in this field, the coordinate where the layout ends (point file) is provided;

Finally, on this same screen, two more fields must be filled in, namely:
Backlink; and
Traçado.shp.

The Backlink field refers to an address where the file is located that allows the output data (module 8) to be read automatically by the tool represented by module 10. This file allows the workflow to develop as it chains sequences of geoprocessing tools, feeding the output of one tool into another tool as input. The Traçado.shp field refers to an address where the final file (lowest cost layout in polyline format) will be saved and later viewed.

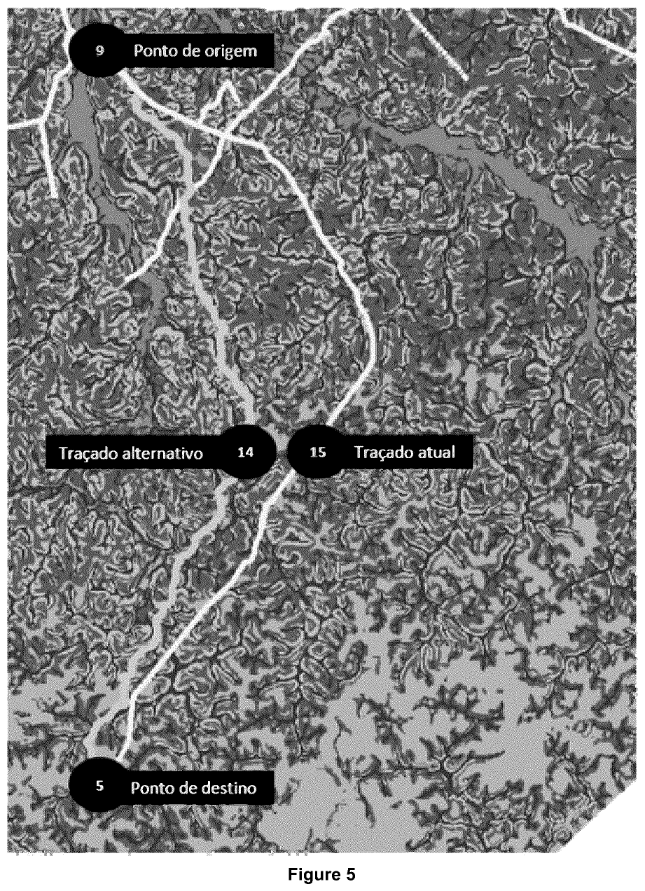

FIG. 5 shows the simulation of a new layout 14 as opposed to the current layout 15 in an area of the thematic map depicting aptitude for opening roads, pipelines and operating locations in Urucu, along with origin 9 and destination 5 points. It can be noted that the current layout is approximately 600 meters longer than the proposed one and that one third of it crosses soils of very poor to poor aptitude, as described in Table 3. Considering only the difference in the length reported and data from the National Department of Transport Infrastructure, the cost of implementing the new layout could be R$ 900,000.00 lower than the current cost. It is believed that both the implementation and maintenance of the proposed new layout could have an even greater cost reduction, in view of the low percentage (4%) of the sections with poorer aptitudes. In relation to environmental conditions, the proposed path, in addition to being shorter, would pass through fewer slopes, areas of streams and floods, reducing vegetation suppression, habitat fragmentation, landfills and the risk of erosion and silting.

TABLE 3

| | Section of the current | Section of the proposed |
|---|---|---|
| Aptitude class | layout (%) | layout (%) |
| Very poor (U-shaped | 0 | 0 |
| valleys) | | |
| Very poor (V-shaped | 19.8 | 1.9 |
| valleys) | | |
| Very poor | 1.5 | 0.3 |
| Poor | 12.0 | 1.8 |
| Regular | 2.7 | 0.4 |
| Good | 16.3 | 8.6 |
| Very good | 47.7 | 87.0 |

The toolbox was developed on the ArcGis software platform for the elaboration of road layouts, pipelines and escape routes, allowing simulations and decision-making, using only one point of departure and arrival. It's also worth noting that the method and toolbox proposed here can be used in any land unit, requiring only the existence of a cartographic base containing the following information layers: topographic map, drainage lines, soil map, origin coordinate of the layout, and destination coordinate of the layout. The method of the present invention also works with different scales of detailing, making its use flexible for the information conditions existing in the land unit.

In addition to the method, the aptitude map produced allows quick and accurate access, and expands the capacity of the technicians who work in territorial management and operational activities, preventing and reducing impacts and economic costs.

While aspects of this disclosure may be susceptible to various modifications and alternative forms, specific embodiments have been shown by way of example in the drawings and have been described in detail in this document. But it must be understood that the invention is not intended to be limited to the specific forms disclosed. Instead, the invention must cover all modifications, equivalents, and alternatives that fall within the scope of the invention, as defined by the following attached claims.

1. Method for elaboration of road layouts, pipeline lines and escape routes carried out in a Geographic Information System (GIS), characterized in that it comprises the steps of:
Providing an aptitude map (1) to the GIS, the aptitude map comprising one or more soil mapping units (MU);
Assigning a grade (2) to each of the one or more MUS;
Reclassifying (3) the values of each input pixel of the aptitude map (1) to the values defined by the grades (2);
Defining a destination point (5) and an origin point (9) on the aptitude map;
Calculating (6) the lowest cumulative distance cost for each pixel of the aptitude map (1); and
Calculating (10) the lowest cost layout from the origin point (9) to the destination point (5).

2. Method, according to claim 1, characterized in that it also comprises the steps of:
Generating (11) a raster file that contains the shortest path calculated; and
Converting (12) a set of Raster pixels to a Polyline that represents the shortest path calculated (14).
